(19) United States
(12) Patent Application Publication
(10) Pub. No.: US 2026/0233092 A1
(43) Pub. Date: Aug. 13, 2026

(54) SERVER DEVICE AND INFORMATION PROCESSING DEVICE

(71) Applicant: Sony Interactive Entertainment Inc., Tokyo (JP)

(72) Inventor: Tatsuki Amimoto, Tokyo (JP)

(73) Assignee: Sony Interactive Entertainment Inc., Tokyo (JP)

(21) Appl. No.: 19/154,766

(22) PCT Filed: Mar. 9, 2023
(86) PCT No.: PCT/JP2023/009005

§ 371 Date: Aug. 7, 2025

(51) Int. Cl. A63F 13/35; A63F 13/533; A63F 13/69; A63F 13/79

(52) U.S. Cl. CPC A63F 13/35; A63F 13/533; A63F 13/69; A63F 13/79; A63F 2300/638

(57) ABSTRACT

A recording device 230 records play data including identification information regarding an event that has occurred during gameplay by a plurality of players and time information indicating a time at which the event has occurred. A performance period specifying unit 212 specifies, from play data related to an activity having a completion condition set thereto, a period during which the activity has been performed. An activity specifying unit 214 specifies an activity with a likelihood of having been involved in the occurrence of the event, on the basis of a relation between the period during which the activity has been performed and the time information included in the play data. A degree-of-involvement derivation unit 216 derives a degree of involvement indicating an extent of likelihood that the activity specified is involved in the occurrence of the event.

### TECHNICAL FIELD

The present disclosure relates to a technology for presenting information for supporting gameplay to a user.

### BACKGROUND ART

PTL 1 discloses a game program for outputting event information indicating the start or completion of an activity, which is a unit of gameplay. In an information processing system disclosed in PTL 1, a game apparatus operated by a player transmits, to a server apparatus, event data including event information output by the game program. The server apparatus collects pieces of event data from a plurality of information processing apparatuses and derives a predicted playtime for the activity.

PTL 2 discloses a server apparatus configured to support a user in earning trophies, which are virtual awards. This server apparatus extracts a relation related to the earning order of trophies on the basis of the order in which a plurality of players have earned a plurality of trophies, refers to the relation, and notifies the user of information associated with trophies with a likelihood of being earned next by the user.

### CITATION LIST

### Patent Literature

### [PTL 1]

Japanese Patent Laid-open No. 2022-63756

### [PTL 2]

Japanese Patent Laid-open No. 2022-57395

### SUMMARY

### Technical Problems

Since earned trophies serve as indicators of how thoroughly a game has been played, users want to earn trophies efficiently. Therefore, it is demanded to implement a mechanism configured to present, to users, information associated with trophies that can be earned in the future. Further, in addition to trophies, it is preferable to present, to users, information associated with game items such as weapons or armor that can be earned in the future and thereby enable the support of the acquisition of game items.

### Solution to Problems

A server apparatus of a certain aspect of the present disclosure includes a recording device configured to record play data including identification information regarding an event that has occurred during gameplay by a plurality of players and time information indicating a time at which the event has occurred and one or more processors including hardware. The one or more processors are configured to specify, from play data related to an activity having a completion condition set thereto, a period during which the activity has been performed, specify an activity with a likelihood of having been involved in the occurrence of the event, on the basis of a relation between the period during which the activity has been performed and the time information included in the play data, and derive a degree of involvement indicating an extent of likelihood that the activity specified is involved in the occurrence of the event.

An information processing apparatus of another aspect of the present disclosure includes one or more processors including hardware. The one or more processors display an activity with a relatively high likelihood of being involved in earning a virtual award.

Note that any combination of the above components and conversions of the expressions of the present disclosure between methods, apparatuses, systems, recording media, computer programs, and the like are also effective as aspects of the present disclosure.

### BRIEF DESCRIPTION OF DRAWINGS

FIG. 1 is a diagram illustrating a game system according to an embodiment.

FIG. 2 is a diagram illustrating a hardware configuration of an information processing apparatus.

FIG. 3 is a diagram illustrating functional blocks of the information processing apparatus.

FIG. 4 is a diagram illustrating an example of a game image.

FIG. 5 is a diagram illustrating functional blocks of a server apparatus.

FIG. 6 is a flowchart illustrating a procedure for statistically processing play data.

FIG. 7 is a diagram illustrating an example of the timeline of performed activities.

FIG. 8 is a diagram illustrating an example of a temporal relation between performed activities and timings at which trophies have been earned.

FIG. 9 is a diagram illustrating an example of a notification area to be displayed.

FIG. 10 is a diagram illustrating an example of a notification area to be displayed.

FIG. 11 is a diagram illustrating an example of a notification area to be displayed.

FIG. 12 is a diagram illustrating an example of a notification area to be displayed.

FIG. 13 is a diagram illustrating examples of notification areas to be displayed.

FIG. 14 is a diagram illustrating examples of notification areas to be displayed.

FIG. 15 is a diagram illustrating an example of a notification area to be displayed.

### DESCRIPTION OF EMBODIMENT

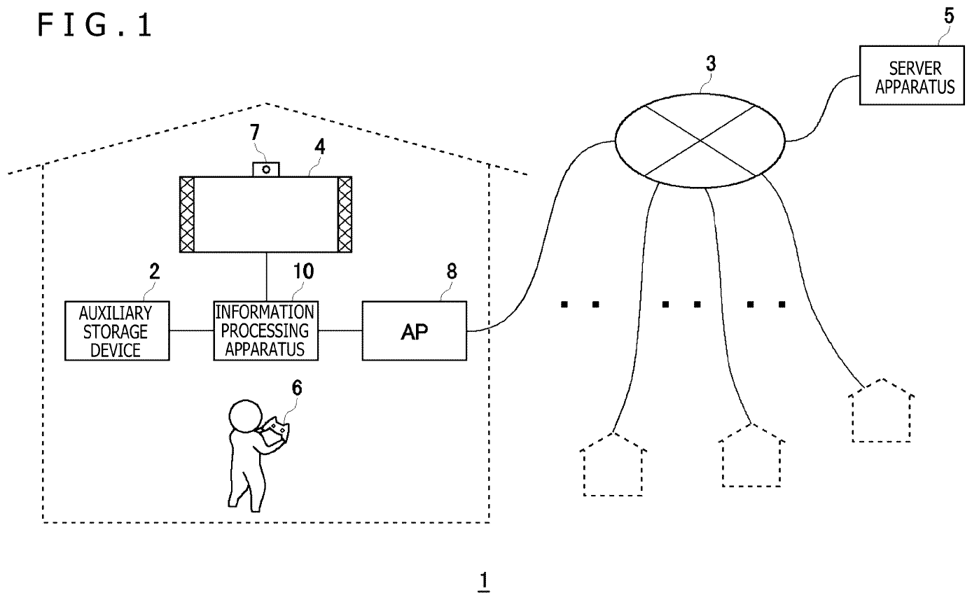

FIG. 1 illustrates a game system 1 according to an embodiment of the present disclosure. The game system 1 of the embodiment includes an information processing apparatus 10, which is operated by a user, and a server apparatus 5. The game system 1 presents, to the user, information for supporting the earning of virtual awards (trophies) that are granted when predetermined achievement conditions are met in a game, as well as the acquisition of game items for efficient game progression, thereby implementing an environment in which the user can play the game efficiently.

An access point (hereinafter referred to as an “AP”) 8 has functions of a wireless access point and a router. The information processing apparatus 10 is connected to the AP 8 via a wireless or wired connection and is communicably connected to the server apparatus 5 on a network 3 such as the Internet. While FIG. 1 illustrates the single user and the single information processing apparatus 10, in the game system 1, a plurality of information processing apparatuses 10 operated by a plurality of users are connected to the server apparatus 5 via the network 3.

The information processing apparatus 10 is connected to an input apparatus 6, which is operated by the user, wirelessly or with a cable. The input apparatus 6 outputs information regarding operations performed by the user to the information processing apparatus 10. When receiving the operation information from the input apparatus 6, the information processing apparatus 10 reflects the operation information in the processing of system software or game software and causes an output apparatus 4 to output the result of the processing. In the game system 1, the information processing apparatus 10 is a game apparatus (game console) configured to execute games, and the input apparatus 6 is equipment, such as a game controller, configured to supply user operation information to the information processing apparatus 10. Note that the input apparatus 6 may be an input interface such as a keyboard or a mouse.

An auxiliary storage device 2 is a large-capacity recording device, such as a hard disk drive (HDD) or a solid-state drive (SSD). The auxiliary storage device 2 may be an internal recording device or an external recording device that is connected to the information processing apparatus 10 through a universal serial bus (USB) or the like. The output apparatus 4 may be a television including a display configured to output images and a speaker configured to output sound. The output apparatus 4 may be connected to the information processing apparatus 10 through a wired cable or wirelessly.

A camera 7, which is an imaging device, is provided in the vicinity of the output apparatus 4 and captures images of the space around the output apparatus 4. FIG. 1 illustrates an example in which the camera 7 is mounted on the upper part of the output apparatus 4; however, the camera 7 may be disposed on the side part or lower part of the output apparatus 4. In any case, the camera 7 is disposed at a position that enables the capturing of images of the user located in front of the output apparatus 4. The camera 7 may be a stereo camera.

The server apparatus 5 provides network services to the user of the game system 1. The server apparatus 5 manages user accounts for identifying the user, and the user signs in to the network services provided by the server apparatus 5, by using the user account. By signing in to the network services from the information processing apparatus 10, the user can register game save data and trophies, which are virtual awards earned during gameplay, with the server apparatus 5. By registering the save data and the trophies with the server apparatus 5, the user can synchronize the save data and the trophies even when using an information processing apparatus different from the information processing apparatus 10.

Further, the server apparatus 5 manages game communities or the like to provide services for the user to enjoy games. The server apparatus 5 collects, from the information processing apparatuses 10 of the plurality of users, pieces of play data indicating the gameplay situations of the users. By analyzing the pieces of play data of the plurality of users, the server apparatus 5 derives information for supporting gameplay and provides the play support information to the information processing apparatus 10.

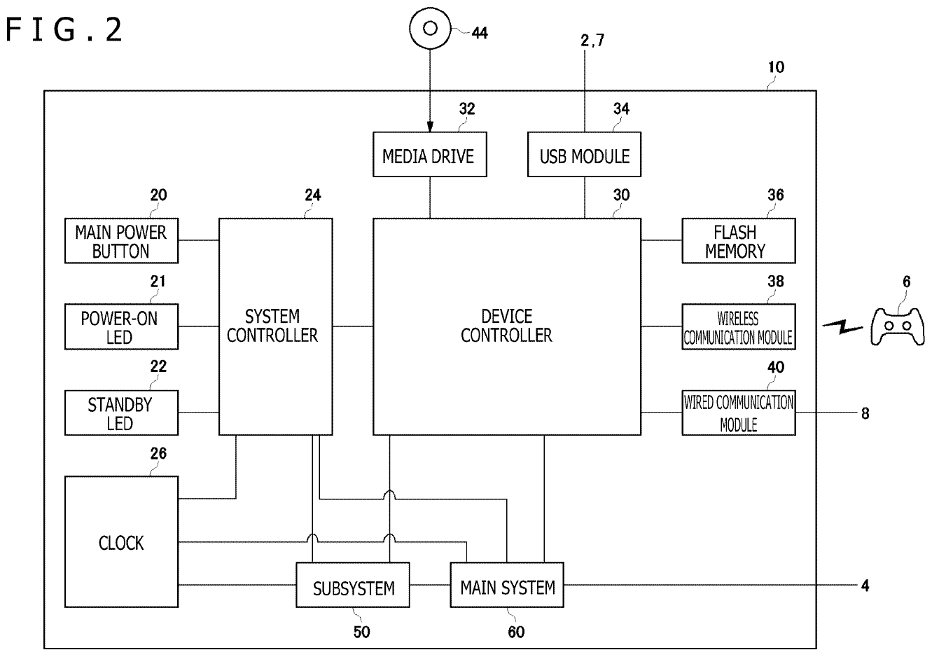

FIG. 2 illustrates a hardware configuration of the information processing apparatus 10. The information processing apparatus 10 includes a main power button 20, a power-on light emitting diode (LED) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main central processing unit (CPU), a memory which serves as a main storage device, a memory controller, a graphics processing unit (GPU), and the like. The GPU is mainly used for the arithmetic processing of game programs. The main CPU has functions of starting system software and executing, under the environment provided by the system software, game programs installed in the auxiliary storage device 2. The subsystem 50 includes a sub-CPU, a memory which serves as a main storage device, a memory controller, and the like, but does not include a GPU.

While the main CPU has a function of executing game programs installed in the auxiliary storage device 2, the sub-CPU does not have such a function. However, the sub-CPU has a function of accessing the auxiliary storage device 2 and a function of transmitting and receiving data to and from the server apparatus 5. The sub-CPU has only such limited processing functions and can thus operate with low power consumption compared to the main CPU. These functions of the sub-CPU are executed when the main CPU is in a standby state.

The main power button 20 is an input section configured to receive operation input from the user. The main power button 20 is provided on the front surface of a housing of the information processing apparatus 10 and is operated to turn on or off the power supply to the main system 60 of the information processing apparatus 10. The power-on LED 21 lights up when the main power button 20 is turned on, and the standby LED 22 lights up when the main power button 20 is turned off. The system controller 24 detects the depression of the main power button 20 by the user.

The clock 26 is a real-time clock. The clock 26 generates current date and time information and supplies the current date and time information to the system controller 24, the subsystem 50, and the main system 60.

The device controller 30 is configured as a large-scale integrated circuit (LSI) configured to execute transfer of information between devices, like a southbridge. As illustrated in FIG. 2, such devices as the system controller 24, the media drive 32, the USB module 34, the flash memory 36, the wireless communication module 38, the wired communication module 40, the subsystem 50, and the main system 60 are connected to the device controller 30. The device controller 30 absorbs the differences in electrical characteristics and the variations in data transfer speeds among the devices and controls the timing of data transfer.

The media drive 32 is a drive device configured to be driven with a read only memory (ROM) medium 44 mounted thereon, the ROM medium 44 having recorded thereon application software such as games and license information and to read out programs, data, and the like from the ROM medium 44. The ROM medium 44 is a read-only recording medium, such as an optical disc, a magneto-optical disk, or a Blu-ray disc.

The USB module 34 is a module for a connection to external equipment through a USB cable. The USB module 34 may be connected to the auxiliary storage device 2 and the camera 7 through USB cables. The flash memory 36 is an auxiliary storage device forming internal storage. The wireless communication module 38 communicates wirelessly with the input apparatus 6 by using communication protocols such as the Bluetooth (registered trademark) protocol or the Institute of Electrical and Electronics Engineers (IEEE) 802.11 protocol. The wired communication module 40 communicates with external equipment with a cable and is connected to the network 3 via the AP 8.

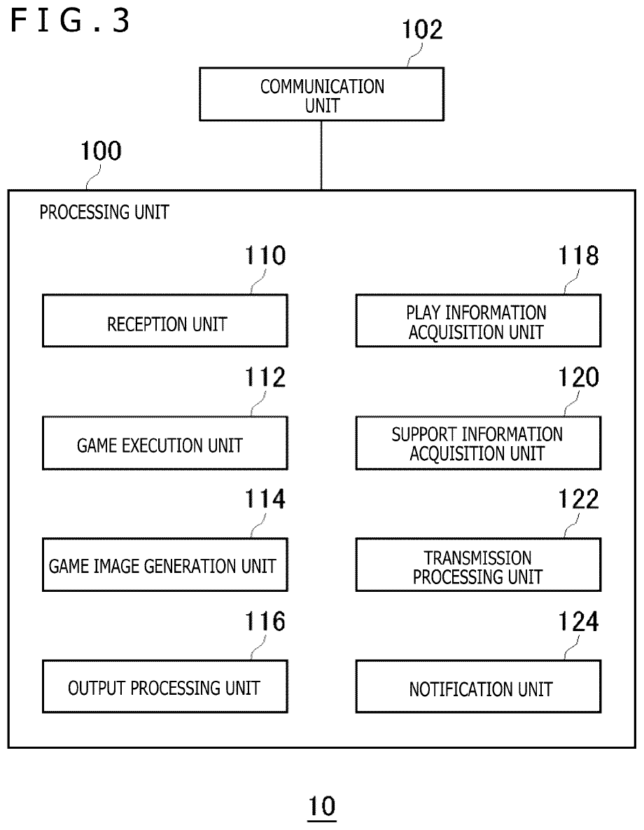

FIG. 3 illustrates functional blocks of the information processing apparatus 10. The information processing apparatus 10 includes a processing unit 100 and a communication unit 102 and executes game software installed in the auxiliary storage device 2. The processing unit 100 includes a reception unit 110, a game execution unit 112, a game image generation unit 114, an output processing unit 116, a play information acquisition unit 118, a support information acquisition unit 120, a transmission processing unit 122, and a notification unit 124.

The information processing apparatus 10 includes a computer, and the computer executes programs to implement the various functions illustrated in FIG. 3. The computer includes, as hardware, a memory configured to load programs, one or more processors configured to execute loaded programs, an auxiliary storage device, other LSIs, and the like. The processor includes a plurality of electronic circuits including semiconductor integrated circuits or LSIs, and the plurality of electronic circuits may be mounted on a single chip or on a plurality of chips. The functional blocks illustrated in FIG. 3 are implemented by cooperation between hardware and software. Thus, it is to be understood by those skilled in the art that these functional blocks can be implemented in various forms, such as by hardware alone, by software alone, or by a combination of the two.

The communication unit 102 receives information regarding operations for gameplay by the user on the input apparatus 6 (operation information) and provides the information to the reception unit 110. When receiving the game operation information from the user, the reception unit 110 provides the game operation information to the game execution unit 112.

Further, the communication unit 102 communicates with the server apparatus 5 to transmit and receive various types of information or data. The communication unit 102 may have the functions of both the wireless communication module 38 and the wired communication module 40.

The game execution unit 112 executes the game software on the basis of the user operation information. The game software includes at least a game program, image data, and sound data. During gameplay by the user, the reception unit 110 receives the user operation information, and the game execution unit 112 performs arithmetic processing to move a player character in a virtual space on the basis of the user operation information.

The game image generation unit 114 includes a GPU, and generates a game image from a viewpoint position (virtual camera) in the virtual space in response to the result of the arithmetic processing in the virtual space. Further, a game sound generation unit (not illustrated) generates game sound at the viewpoint position in the virtual space.

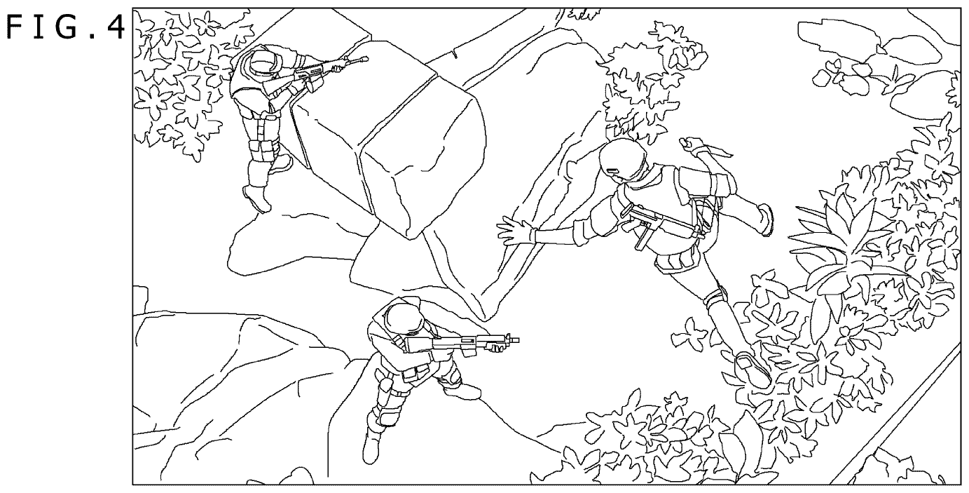

FIG. 4 illustrates an example of a game image to be displayed on the output apparatus 4. The output processing unit 116 outputs game images and game sound from the output apparatus 4. The user views the game images and listens to the game sound while operating the input apparatus 6 to play the game.

The game program of the embodiment outputs, when an event occurs during gameplay, event information including information for identifying the occurred event (event ID). The play information acquisition unit 118 acquires the event information and provides the acquired event information to the server apparatus 5, thereby allowing the server apparatus 5 to statistically analyze gameplay trends across the plurality of users. Therefore, it is preferable that the game program include coding for various events.

The game includes a plurality of activities having at least completion conditions set thereto. The completion conditions may be the achievement conditions of the activities. It is preferable that the activities have start conditions set thereto to clearly define the start and the completion. The activities are play units including stages, quests, missions, tournaments, sessions, or the like incorporated in the game. Each activity has play conditions to be achieved on the basis of user operations. In the embodiment, a series of game progressions from the fulfillment of an activity start condition to the fulfillment of an activity completion condition forms a single activity. For example, as a start condition, entering an enemy boss's castle may be set, and as a completion condition, defeating the enemy boss may be set. The activities may be set appropriately by the game developer, and a single quest or mission that appears during game progression may form a single activity.

When starting a certain activity, the game program outputs event information including information for identifying the start event of that activity (event ID) to the play information acquisition unit 118. Further, when completing a certain activity, the game program outputs event information including information for identifying the completion event of that activity (event ID) to the play information acquisition unit 118. The event information may include, in addition to the event ID, information for identifying the activity (activity ID) or information indicating the performance result of the activity (for example, success or failure). Different event IDs are set for each activity.

Note that the events may be set not only for activities but also for various incidents or situational changes that occur in the game. For example, the events may be set for actions such as the player-operated character (player character) obtaining special weapons or special recovery items. Further, the events may be set for the fact that the player character has defeated a predetermined number of enemies or collected a predetermined number of items. In this manner, the game developer can set events for various in-game incidents and situational changes. When an event occurs during game progression, the game program outputs event information including information for identifying the event (event ID) to the play information acquisition unit 118.

When acquiring the event information, the play information acquisition unit 118 generates play data by adding, to that event information, a user identifier (user account) for identifying the user, a game identifier (game ID) for identifying the game, and time information (timestamp) indicating the time at which the event has occurred. The play information acquisition unit 118 then provides the play data to the transmission processing unit 122. The game program may output event information including the game ID and/or the timestamp to the play information acquisition unit 118. The transmission processing unit 122 transmits the play data provided from the play information acquisition unit 118, to the server apparatus 5 in real time via the communication unit 102.

Further, when the play of the user achieves the unlock conditions for a certain trophy, which is a virtual award, the game program of the embodiment grants the trophy linked to the unlock conditions to the user. There may be prepared trophies of types such as gold trophies, silver trophies, and bronze trophies based on difficulty levels. The granting of trophies serves to enhance the motivation of the user for gameplay and allows the user to compete in the number of earned trophies with other users.

When the unlock conditions for the trophy are achieved, the game program outputs trophy information including information for identifying the unlocked trophy (trophy ID). This trophy ID is information for identifying the action for unlocking the trophy (event) and is a type of event ID. The trophy ID may be created using a coding system that is different from or the same as that of the event ID. Note that, in a case where the same coding system is used, the trophy ID directly corresponds to the event ID. Even in a case where different coding systems are used, the trophy ID is information for identifying an event that has occurred during gameplay, and can be treated as an event ID with a different coding system.

When acquiring the trophy information, the play information acquisition unit 118 generates play data by adding, to that trophy information, a user identifier (user account) for identifying the user, a game identifier (game ID) for identifying the game, and time information (timestamp) indicating the time at which the trophy has been earned. The play information acquisition unit 118 then provides the play data to the transmission processing unit 122. The game program may output trophy information including the game ID and/or the timestamp to the play information acquisition unit 118. The transmission processing unit 122 transmits the play data provided from the play information acquisition unit 118, to the server apparatus 5 in real time via the communication unit 102.

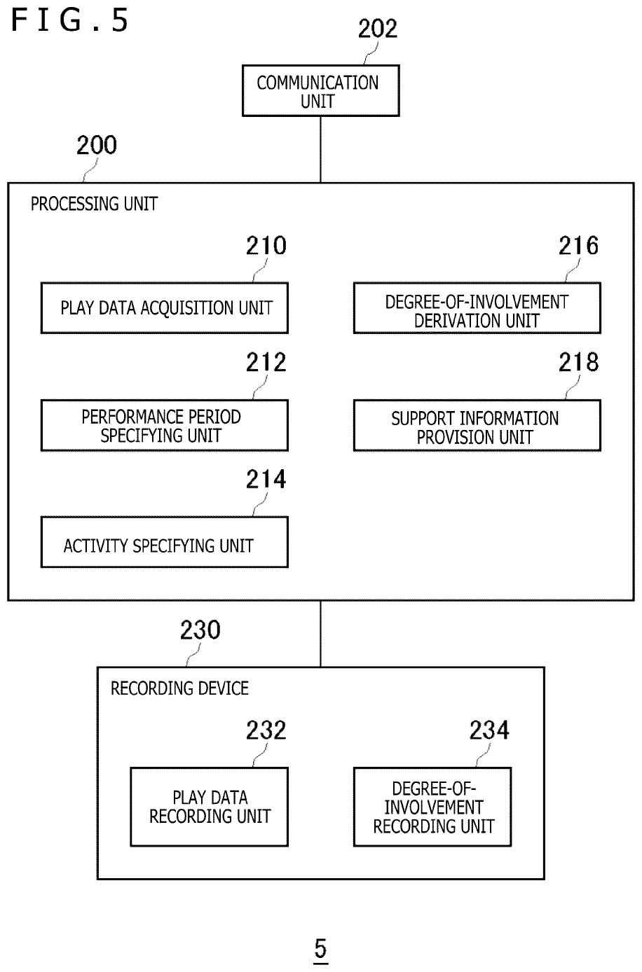

FIG. 5 illustrates functional blocks of the server apparatus 5. The server apparatus 5 includes a processing unit 200, a communication unit 202, and a recording device 230. The processing unit 200 includes a play data acquisition unit 210, a performance period specifying unit 212, an activity specifying unit 214, a degree-of-involvement derivation unit 216, and a support information provision unit 218. The recording device 230 includes a play data recording unit 232 and a degree-of-involvement recording unit 234.

The server apparatus 5 includes a computer. The computer executes programs to implement the various functions illustrated in FIG. 5. The computer includes, as hardware, a memory configured to load programs, one or more processors configured to execute loaded programs, an auxiliary storage device, other LSIs, and the like. The processor includes a plurality of electronic circuits including semiconductor integrated circuits or LSIs, and the plurality of electronic circuits may be mounted on a single chip or on a plurality of chips. The functional blocks illustrated in FIG. 5 are implemented by cooperation between hardware and software. Thus, it is to be understood by those skilled in the art that these functional blocks can be implemented in various forms, such as by hardware alone, by software alone, or by a combination of the two.

The play data acquisition unit 210 acquires pieces of play data from the plurality of information processing apparatuses 10 operated by the plurality of players and records the pieces of play data in the play data recording unit 232. The play data recording unit 232 records the pieces of play data for each game title by linking the play data to each of the user accounts. Thus, the play data recording unit 232 records play data including at least identification information regarding an event (event ID, trophy ID) that has occurred during gameplay by the plurality of players and time information (timestamp) indicating the time at which the event has occurred. The server apparatus 5 has a function of examining the pieces of play data to statistically analyze game play trends. Now, there is described a procedure in which the server apparatus 5 statistically processes collected pieces of play data to derive information for supporting the acquisition of trophies or game items.

### Derivation Processing of Play Support Information

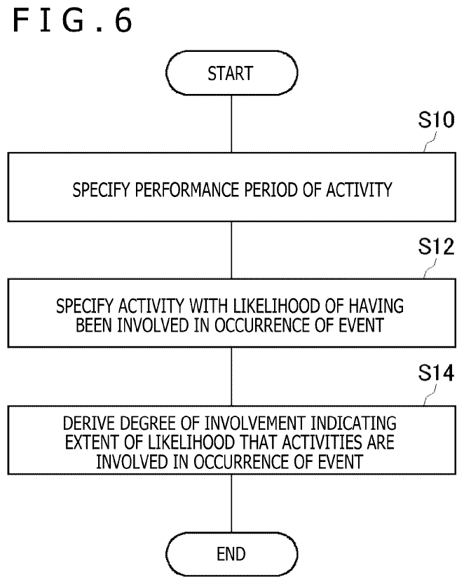

FIG. 6 is a flowchart illustrating a procedure for statistically processing collected pieces of play data. The performance period specifying unit 212 extracts play data related to an activity from among pieces of play data recorded in the play data recording unit 232 and specifies the period during which the activity has been performed (S10). Here, the play data related to the activity includes the play data of the start event of the activity and the play data of the completion event of the activity.

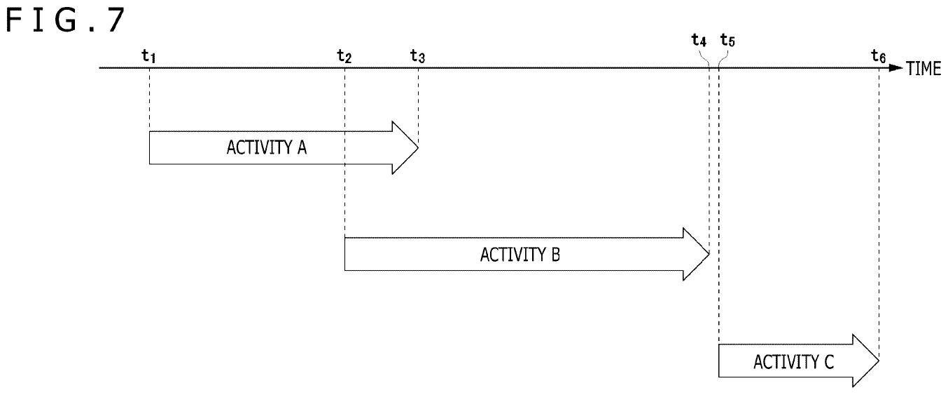

FIG. 7 illustrates an example of the timeline of activities performed during gameplay. In FIG. 7, the activities performed by a player x when playing a game title Y are arranged along a time axis. The performance period specifying unit 212 reads the respective timestamps from the play data of the start event of the activity and the play data of the completion event of the activity, thereby specifying the period during which the activity has been performed.

In this example, an activity A is performed between a time t₁ and a time t₃, an activity B is performed between a time t₂ and a time t₄, and an activity C is performed between a time t₅ and a time t₆. As illustrated in FIG. 7, both the activity A and the activity B are performed between the time t₂ and the time t₃, while no activities are performed between the time t₄ and the time t₅. In this manner, during gameplay, there are periods during which a plurality of activities are performed and periods during which no activities are performed.

In a case where start conditions and completion conditions for activities are set, the performance period specifying unit 212 can accurately specify, from the timestamp of the start event of an activity and the timestamp of the completion event of the activity, the period during which the activity has been performed, as illustrated in FIG. 7. However, there are some activities for which completion conditions are set but start conditions are not set. In this case, the performance period specifying unit 212 may specify, only from the timestamp of the completion event of an activity, the period during which the activity has been performed. For example, a predetermined period of time (for example, 30 seconds) before the completion of an activity may be set as the start time of the activity to specify the period during which the activity has been performed.

In the embodiment, the server apparatus 5 analyzes the interrelation between activities and trophies on the basis of play data indicating the play situations of the plurality of players. The server apparatus 5 determines the interrelation between activities and trophies, thereby making it possible to present, to a user who wants to earn a certain trophy, play support information indicating which activity is to be performed.

The activity specifying unit 214 specifies an activity with a likelihood of having been involved in the occurrence of an event, on the basis of the relation between the period during which the activity has been performed and the time information included in the play data (S12). In the following, the activity specifying unit 214 specifies an activity with a likelihood of having been involved in earning a trophy, on the basis of the relation between the period during which the activity has been performed and the time information included in the play data related to trophy earning.

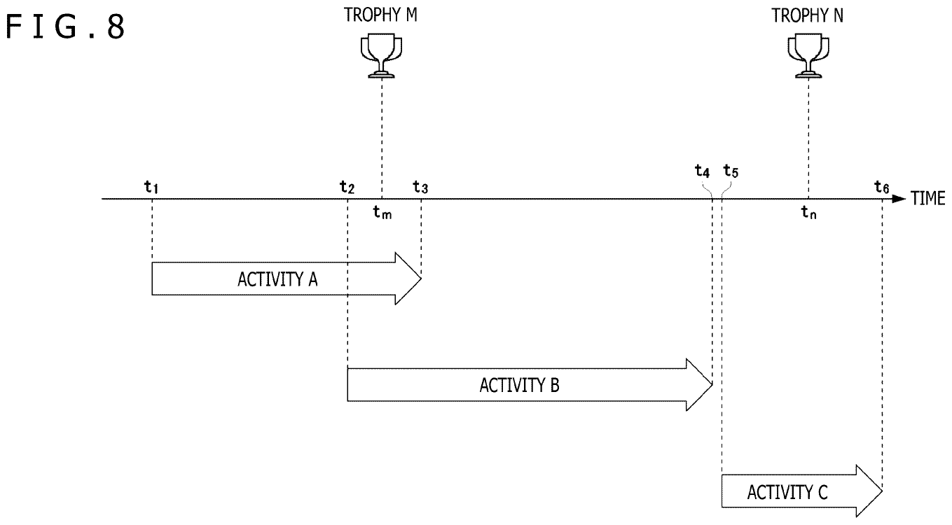

FIG. 8 illustrates an example of a temporal relation between performed activities and timings at which trophies have been earned. In FIG. 8, the timings at which the player X has earned a trophy M and a trophy N when playing the game title Y are illustrated. The activity specifying unit 214 specifies that the earning timing of the trophy M is tₘ from the play data related to the earning of the trophy M, and specifies that the earning timing of the trophy N is tₙ from the play data related to the earning of the trophy N.

As illustrated in FIG. 8, when the trophy M has been earned (time tₘ), both the activity A and the activity B have been performed. This means that there is a likelihood that the trophy M has been earned as a result of the activity A and/or the activity B having been performed. Thus, the activity specifying unit 214 determines that there is a likelihood that the activity A and the activity B have been involved in earning the trophy M. That is, the activity specifying unit 214 specifies the activity A and the activity B as activities with a likelihood of having been involved in earning the trophy M.

Further, when the trophy N has been earned (time tₙ), the activity C has been performed. This means that there is a likelihood that the trophy N has been earned as a result of the activity C having been performed. Thus, the activity specifying unit 214 determines that there is a likelihood that the activity C has been involved in earning the trophy N. That is, the activity specifying unit 214 specifies the activity C as an activity with a likelihood of having been involved in earning the trophy N.

In this manner, by specifying activities performed at the time of the occurrence of an event (at the time of the earning of a trophy), the activity specifying unit 214 specifies activities with a likelihood of having been involved in the occurrence of the event.

In the manner described above, the activities performed when the player X has earned the trophies M and N in the game title Y are specified. The activity specifying unit 214 specifies a plurality of activities with a likelihood of having been involved in the occurrence of the same event during gameplay by the plurality of players. The degree-of-involvement derivation unit 216 derives the degrees of involvement indicating the extent of the likelihood that the specified activities are involved in the occurrence of the event (S14).

Now, there is described processing in which the server apparatus 5 statistically processes the pieces of play data of a plurality of players who have played the game title Y and thereby derives the degrees of involvement of a plurality of activities with a likelihood of having been involved in earning the trophy M.

First, the performance period specifying unit 212 extracts, from the pieces of play data of the game title Y recorded in the play data recording unit 232, pieces of play data related to activities for each player, and specifies the periods during which each player has performed the activities. With this, the periods during which each of the plurality of players who have played the game title Y has performed the activities are specified.

Next, the activity specifying unit 214 specifies play data indicating that the trophy M has been earned, from the pieces of play data of the game title Y recorded in the play data recording unit 232, and specifies activities performed when each player has earned the trophy M. The activity specifying unit 214 counts the total number of players who have earned the trophy M, while counting, for each activity, the number of times that the relevant activity has been performed at the time of the earning of the trophy M. Note that the number of times that an activity has been performed is equal to the number of players who have performed the relevant activity when the trophy M has been earned.

Here, it is assumed that the total number of players who have earned the trophy M is 100. It is assumed that, as the activities performed when the trophy M has been earned, the activity A, the activity B, an activity F, an activity H, and an activity K are specified and that the number of players who have performed each of the activities is as follows.
Activity A: 65 players
Activity B: 32 players
Activity F: 25 players
Activity H: 10 players
Activity K: 3 players

Note that, as illustrated in FIG. 8, since there is a player who has performed a plurality of activities (the activity A and the activity B) at the time of the earning of the trophy M, such as the player X, the sum of players who have performed each of the activities exceeds the total number of players, which is 100.

The degree-of-involvement derivation unit 216 derives, from the total number of players who have earned the trophy M and the number of players who have performed each of the activities, the probabilities that each activity is being performed at the time of the occurrence of the event, as the degree of involvement indicating the extent of the likelihood that each activity is involved in the occurrence of the event.

Specifically, the degree-of-involvement derivation unit 216 derives the probabilities that the activities are being performed at the time of the earning of the trophy M, as follows.
Degree of involvement of activity A: 65% (=65/100)
Degree of involvement of activity B: 32% (=32/100)
Degree of involvement of activity F: 25% (=25/100)
Degree of involvement of activity H: 10% (=10/100)
Degree of involvement of activity K: 3% (=3/100)

From these analysis results, it is found that performing the activity A provides a high likelihood of enabling the earning of the trophy M. The activity specifying unit 214 specifies, regarding all trophies, activities performed at the time of trophy earning, and the degree-of-involvement derivation unit 216 derives the probabilities that the specified activities are being performed at the time of trophy earning, thereby making it possible to specify activities strongly correlated with the earning of each trophy. The degree-of-involvement derivation unit 216 records, in the degree-of-involvement recording unit 234, the degrees of involvement (probabilities) of the activities derived for each trophy.

In the above-mentioned example, the performance period specifying unit 212 specifies the period during which an activity has been performed, on the basis of the play data of at least the completion event, and the activity specifying unit 214 specifies an activity performed at the time of the occurrence of an event as an activity with a likelihood of having been involved in the occurrence of the event. In a modified example, the activity specifying unit 214 may specify, in a case where an event has occurred during the period from the completion of an activity to elapse of a predetermined period of time (for example, 30 seconds), the activity as an activity with a likelihood of having been involved in the occurrence of the event. In this way, in a case where, after the completion of an activity, a trophy attributable to the completion of the activity is granted to the user, the activity specifying unit 214 can specify the activity as an activity with a likelihood of having been involved in earning the trophy.

### Presentation Processing of Play Support Information

The server apparatus 5 provides information for supporting the gameplay of the user, by using the degrees of involvement of activities recorded in the degree-of-involvement recording unit 234.

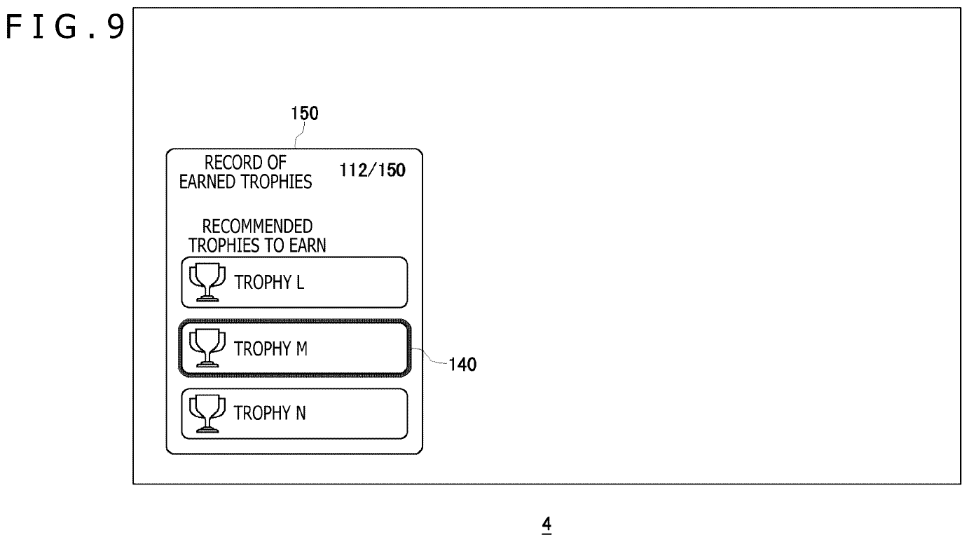

FIG. 9 illustrates an example of a notification area 150 to be displayed on the output apparatus 4. During gameplay, when the user inputs a predetermined operation to the input apparatus 6, the notification unit 124 requests provision of play support information from the server apparatus 5. When the server apparatus 5 receives the provision request for the play support information, the support information provision unit 218 provides play support information associated with trophy earning to the information processing apparatus 10. When receiving the play support information, the notification unit 124 generates notification information associated with the recommended trophies to earn and provides the notification information to the output processing unit 116.

The output processing unit 116 superimposes, for display onto game images, the notification area 150 which includes such notification information. Note that, not only during gameplay, but also at other times, the output processing unit 116 may display the notification area 150 on the output apparatus 4. In the notification area 150 illustrated in FIG. 9, a plurality of recommended trophies to earn, which the user has not earned yet, are displayed, that is, a trophy L, the trophy M, and the trophy N, are displayed here. The user can move a selection frame 140 by operating the input apparatus 6 to place the selection frame 140 on the display area of a desired trophy. The display area of each trophy is configured as a graphical user interface (GUI). When the user operates a predetermined button of the input apparatus 6 with the selection frame 140 placed on a trophy display area, the output processing unit 116 displays a notification area including a group of activities that are involved in earning the trophy in the relevant display area. Here, it is assumed that the user has selected the display area of the trophy M through an operation.

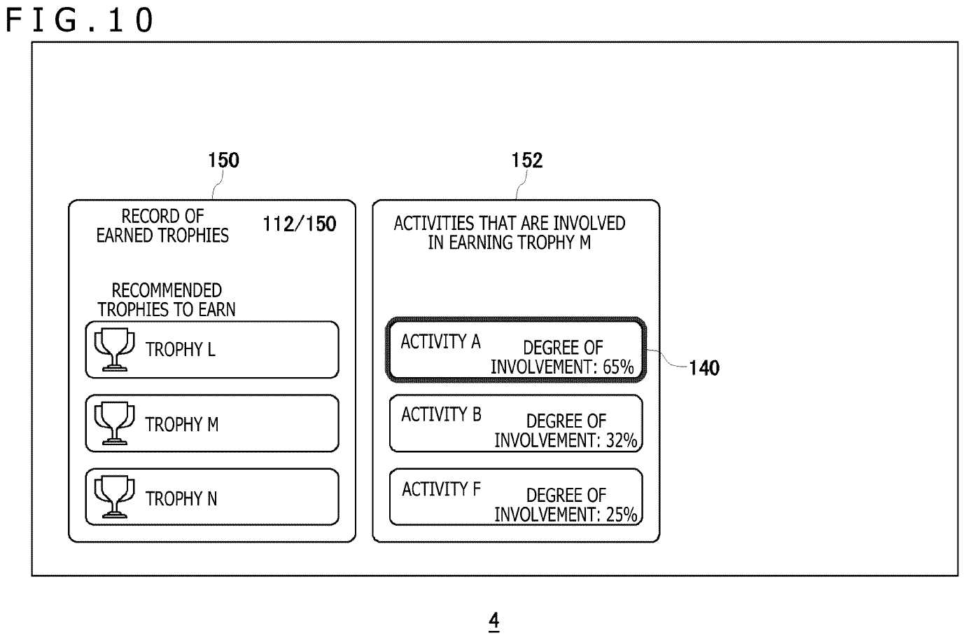

FIG. 10 illustrates an example of a notification area 152 to be displayed on the output apparatus 4. In FIG. 9, when the user selects the display area of the trophy M through an operation, the notification unit 124 requests provision of play support information associated with the earning of the trophy M from the server apparatus 5. When the server apparatus 5 receives the provision request for the play support information, the support information provision unit 218 provides, to the information processing apparatus 10, play support information associated with activities with a relatively high likelihood of being involved in the occurrence of the event (the earning of the trophy M).

As described above, the degree-of-involvement recording unit 234 records, regarding the earning of the trophy M, the following probability information.
Degree of involvement of activity A: 65%
Degree of involvement of activity B: 32%
Degree of involvement of activity F: 25%
Degree of involvement of activity H: 10%
Degree of involvement of activity K: 3%

The support information provision unit 218 may extract activities with the degrees of involvement that are equal to or greater than a predetermined threshold (for example, 15%), and may provide play support information including at least the activity names and the degrees of involvement to the information processing apparatus 10. If the degree of involvement is low, it is difficult to say that the trophy M can be earned by performing that activity. It is thus preferable for the support information provision unit 218 to provide, to the information processing apparatus 10, only activities indicating the degrees of involvement that are equal to or greater than the predetermined threshold. When receiving the play support information, the notification unit 124 generates notification information associated with the activities that are involved in earning the trophy M, and provides the notification information to the output processing unit 116.

The output processing unit 116 superimposes, for display onto game images, the notification area 152 which includes the activity names and the degrees of involvement. The notification area 152 illustrated in FIG. 10 includes a plurality of activities with a high likelihood of being involved in earning the trophy M. The plurality of activities may be displayed in descending order of the degree of involvement. In this example, the activity A, the activity B, and the activity F are displayed from top to bottom, thereby making the relative relation of the degrees of involvement recognizable at a glance. Note that, in the notification area 152 illustrated in FIG. 10, the degrees of involvement are displayed in association with the activity names, thereby allowing the user to compare the degrees of involvement of the activities and recognize that playing the activity A is the best choice for earning the trophy M.

The user moves the selection frame 140 by operating the input apparatus 6 to place the selection frame 140 on the display area of a desired activity. The display area of each activity is configured as a GUI. When the user selects any of the activity display areas through an operation, the output processing unit 116 displays a notification area including a start button for playing the activity in the relevant display area. Here, it is assumed that the user has selected the display area of the activity A through an operation.

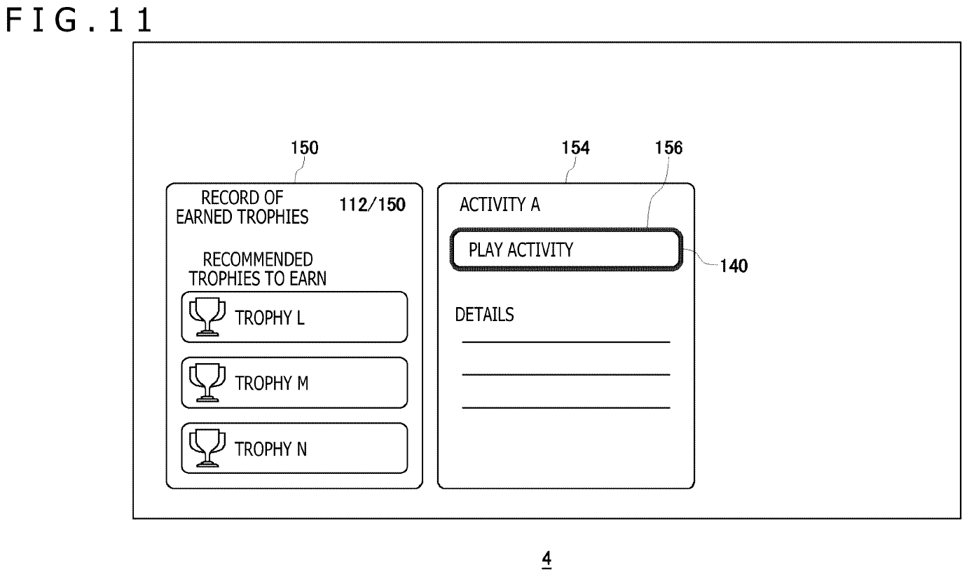

FIG. 11 illustrates an example of a notification area 154 to be displayed on the output apparatus 4. In FIG. 10, when the user selects the display area of the activity A through an operation, the notification unit 124 requests provision of detailed information regarding the activity A from the server apparatus 5. When the server apparatus 5 receives the provision request for the detailed information regarding the activity A, the support information provision unit 218 provides the detailed information regarding the activity A to the information processing apparatus 10.

The output processing unit 116 superimposes, for display onto game images, the notification area 154 which includes a start button 156 for the activity A and the detailed information regarding the activity A. When the user places the selection frame 140 on the start button 156 and operates a predetermined button of the input apparatus 6, the reception unit 110 receives the play request for the activity A and supplies the play request to the game execution unit 112. The game execution unit 112 then starts the activity A. In the manner described above, the user can recognize activities with a high likelihood of enabling the earning of the trophy M and play the activities.

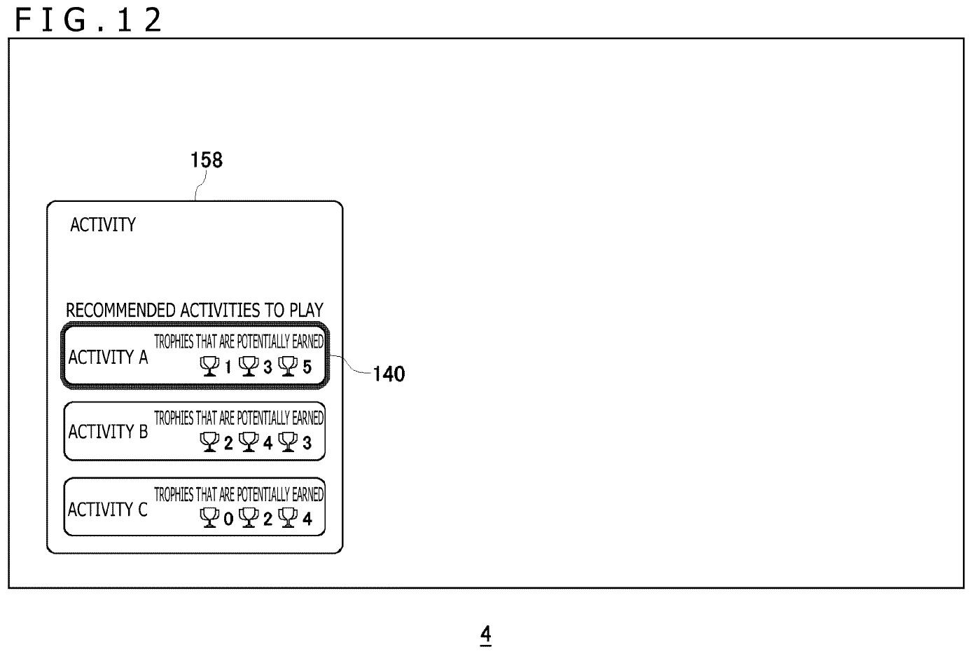

FIG. 12 illustrates an example of a notification area 158, which is another notification area, to be displayed on the output apparatus 4. When the user performs a predetermined operation during gameplay, the notification unit 124 requests provision of play support information from the server apparatus 5. When the server apparatus 5 receives the provision request for the play support information, the support information provision unit 218 provides play support information associated with recommended activities to the information processing apparatus 10.

This play support information includes information associated with trophies with a likelihood of being earned by playing the activities. The support information provision unit 218 refers to the degrees of involvement recorded in the degree-of-involvement recording unit 234, specifies trophies with a likelihood of being earned by playing the activities, and counts the number of trophies with a likelihood of being earned for each type of trophy, namely, gold trophies, silver trophies, and bronze trophies. At this time, the support information provision unit 218 excludes already earned trophies and counts the number of unearned trophies with a likelihood of being earned. The support information provision unit 218 provides, to the information processing apparatus 10, play support information including the names of the recommended activities and the number of trophies with a likelihood of being earned. When receiving the play support information, the notification unit 124 generates notification information associated with the recommended activities to play, and provides the notification information to the output processing unit 116.

The output processing unit 116 superimposes, for display onto game images, the notification area 158 which includes the activity names and the number of trophies with a likelihood of being earned. In the notification area 158 illustrated in FIG. 12, a plurality of recommended activities to play are displayed, that is, the activity A, the activity B, and the activity C are displayed here. In the display area of each activity, the number of trophies with a likelihood of being earned by playing the relevant activity is displayed. In this example, the numbers of the three types of trophies are displayed, and from left to right, the numbers of gold trophies, silver trophies, and bronze trophies with a likelihood of being earned are displayed. The user can recognize activities through which the number of earned trophies can be increased, by viewing the notification area 158. For example, when the user operates the input apparatus 6 to place the selection frame 140 on the display area of the activity A and operates a predetermined button of the input apparatus 6, the notification area 154 illustrated in FIG. 11 is displayed to allow the user to play the activity A.

In displaying the list of the recommended activities illustrated in FIG. 12, the support information provision unit 218 may specify, as recommended activities, activities with high degrees of involvement in earning unearned trophies, and may provide play support information associated with the recommended activities to the information processing apparatus 10. In particular, in a case where the number of unearned trophies has decreased, it is preferable that the support information provision unit 218 specify, as recommended activities, activities with high degrees of involvement in earning unearned trophies. When receiving the play support information, the notification unit 124 generates notification information associated with the recommended activities to play, and provides the notification information to the output processing unit 116. The output processing unit 116 may preferentially display, in the notification area 158, activities with a relatively high likelihood of being involved in earning unearned trophies. Specifically, the output processing unit 116 may display a plurality of activities in descending order of the degree of involvement in trophy earning.

Note that the interrelation between trophy earning, which is an example of an event, and activities has been described above, but the event is not limited to trophy earning. For example, the event may be the acquisition of a hard-to-find (rare) game item P. In this case, the degree-of-involvement derivation unit 216 derives, from the total number of players who have acquired the game item P and the number of players who have performed activities at the time of the acquisition of the game item P, the probabilities that the activities are being performed at the time of the acquisition of the game item P, and records the probabilities in the degree-of-involvement recording unit 234.

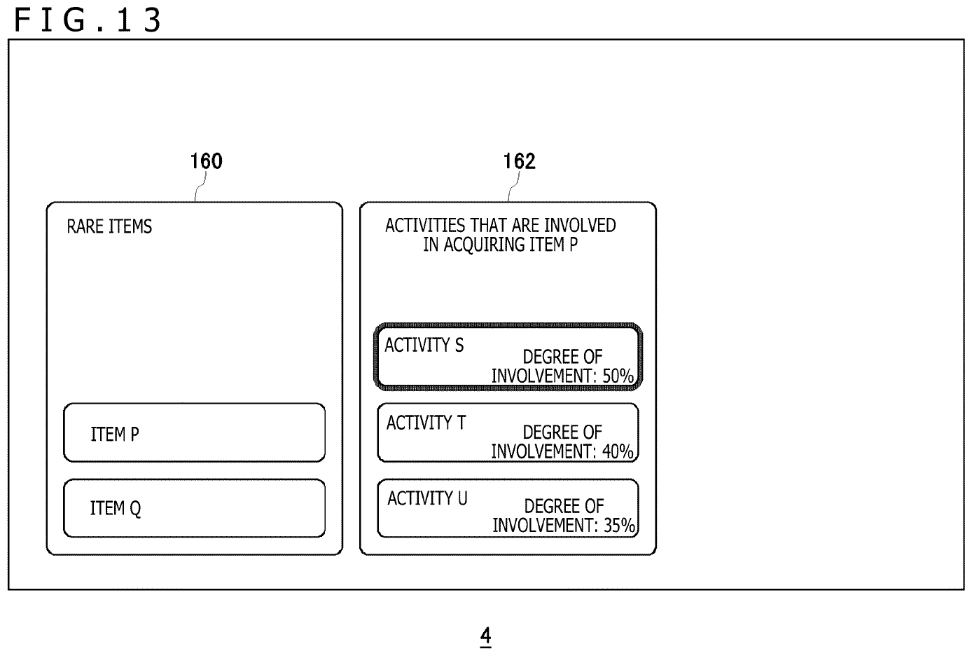

FIG. 13 illustrates examples of notification areas 160 and 162 to be displayed on the output apparatus 4. In the notification area 160, a plurality of rare items are displayed, and in the notification area 162, activities with a relatively high likelihood of being involved in acquiring the rare item P are displayed. In this example, the support information provision unit 218 refers to the degrees of involvement recorded in the degree-of-involvement recording unit 234, specifies activities with a relatively high likelihood of being involved in acquiring the rare item P, and provides play support information including at least the activity names and the degrees of involvement to the information processing apparatus 10. When receiving the play support information, the notification unit 124 generates notification information associated with the activities that are involved in acquiring the rare item P, and provides the notification information to the output processing unit 116.

The output processing unit 116 superimposes, for display onto game images, the notification area 162 which includes the activity names and the degrees of involvement. The notification area 162 includes a plurality of activities with a high likelihood of being involved in acquiring the rare item P. The plurality of activities may be displayed in descending order of the degree of involvement. In this example, an activity S, an activity T, and an activity U are displayed from top to bottom, thereby making the relative relation of the degrees of involvement recognizable at a glance. Note that the degrees of involvement may be displayed in association with the activity names.

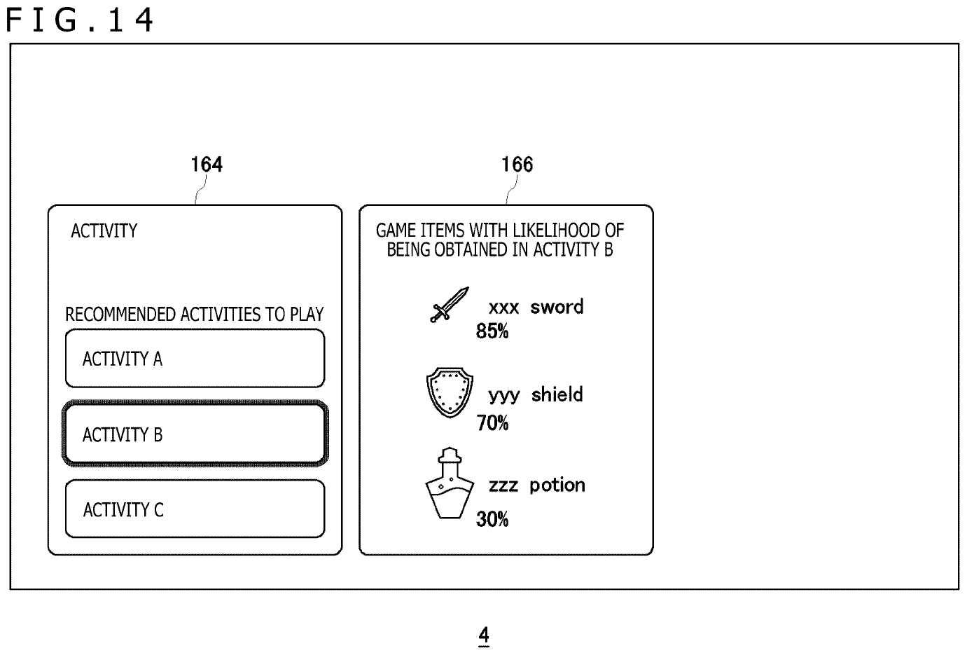

FIG. 14 illustrates examples of notification areas 164 and 166 to be displayed on the output apparatus 4. In the notification area 164, a plurality of recommended activities to play are displayed, and in the notification area 166, game items with a likelihood of being obtained by performing the activity B are displayed. Note that the game items with a likelihood of being obtained may be included within the display area of the activity, as illustrated in FIG. 12.

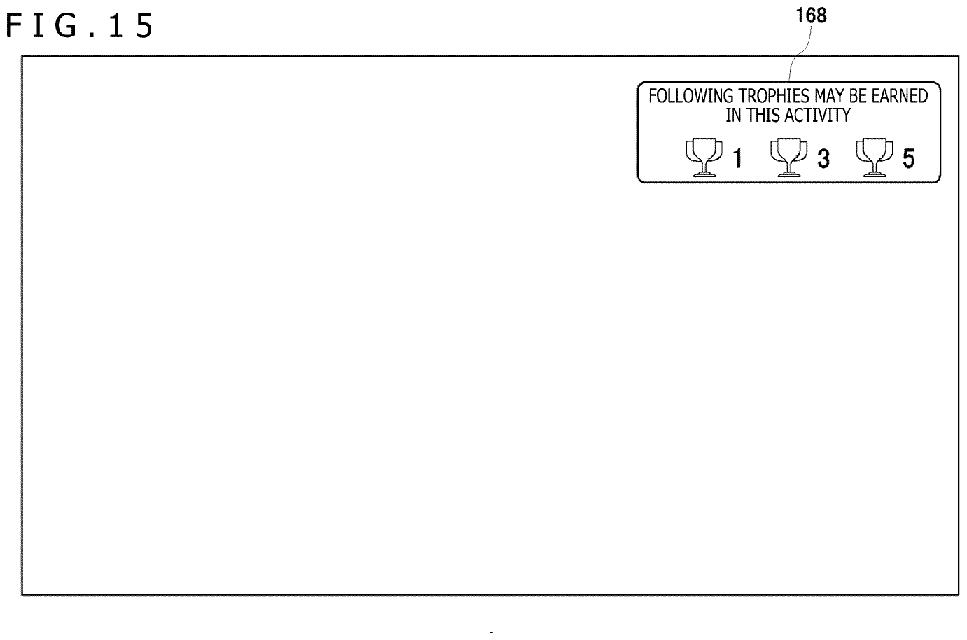

FIG. 15 illustrates an example of a notification area 168 to be displayed. When a certain activity is started, the output processing unit 116 may superimpose, for display onto game images, the notification area 168 which includes information associated with trophies with a likelihood of being earned in the relevant activity. By viewing the display in the notification area 168, the user can enhance their motivation for trophy earning.

The present disclosure has been described above on the basis of the embodiment. This embodiment is illustrative, and it is to be understood by those skilled in the art that various modifications can be made to combinations of the respective components and the respective processing processes of the embodiment, and that such modifications are also within the scope of the present disclosure.

The support information provision unit 218 does not need to include, in the play support information, information associated with activities that the user has already finished playing. Further, the support information provision unit 218 does not need to include, in the play support information, information associated with already acquired trophies or game items. As another example, the support information provision unit 218 may include, in the play support information, information associated with already played activities or information associated with already acquired trophies or game items, but in the information processing apparatus 10, it is preferable that the output processing unit 116 display those pieces of information in a manner that the user cannot select the information (for example, by greying out the information for display).

It is preferable that the output processing unit 116 not display information associated with hidden trophies. Note that, in a case where the user has permitted the disclosure of hidden trophies, the output processing unit 116 may be allowed to display information associated with hidden trophies.

The support information provision unit 218 may provide, to the information processing apparatus 10, information associated with unacquired trophies or game items with a high likelihood of being acquired in activities that the user has already finished playing. Further, the support information provision unit 218 may provide, to the information processing apparatus 10, as play support information, a histogram indicating the distribution of the acquisition timings of trophies or game items during the performance period of an activity. In this histogram, the horizontal axis may be set to the activity progress rate at the time of trophy acquisition, and the vertical axis may be set to the proportion of players who have acquired the trophy or the game item. The activity progress rate may be determined by (the period from activity start to trophy acquisition/the activity performance period).

Further, in a case where an activity includes a plurality of tasks, the support information provision unit 218 may generate, for each task, play support information for presenting the number of trophies with a likelihood of being earned to the user, but may generate play support information collectively including the tasks as the activity. Moreover, in a case where trophies or activities are proposed to the user, the support information provision unit 218 may determine the priority of trophies and/or activities to be proposed, on the basis of the degrees of involvement recorded in the degree-of-involvement recording unit 234.

### INDUSTRIAL APPLICABILITY

The present disclosure can be utilized for technologies for supporting the gameplay of a user.

### REFERENCE SIGNS LIST

1: Game system
5: Server apparatus
10: Information processing apparatus
100: Processing unit
102: Communication unit
110: Reception unit
112: Game execution unit
114: Game image generation unit
116: Output processing unit
118: Play information acquisition unit
120: Support information acquisition unit
122: Transmission processing unit
124: Notification unit
200: Processing unit
202: Communication unit
210: Play data acquisition unit
212: Performance period specifying unit
214: Activity specifying unit
216: Degree-of-involvement derivation unit
218: Support information provision unit
230: Recording device
232: Play data recording unit
234: Degree-of-involvement recording unit

1. A server apparatus comprising:
a recording device configured to record play data including identification information regarding an occurrence of an event during gameplay by a plurality of players and time information indicating a time at which the event has occurred; and
one or more processors including hardware, wherein the one or more processors are configured to:
specify, from play data related to an activity having a completion condition, a period during which the activity has been performed;
specify the activity with a likelihood of having been involved in the occurrence of the event, based at least in part on a relation between the period during which the activity has been performed and the time information included in the play data, and
derive a degree of involvement indicating an extent of likelihood that the activity specified is involved in the occurrence of the event.

2. The server apparatus of claim 1, wherein the one or more processors are further configured to:
specify a plurality of activities with a likelihood of having been involved in occurrence of a same event during the gameplay by the plurality of players, and
derive a respective degree of involvement of each of the plurality of activities.

3. The server apparatus of claim 1, wherein the one or more processors are further configured to specify the activity performed at the time at which the event has occurred.

4. The server apparatus of claim 1, wherein the one or more processors are further configured to specify, in a case where the event has occurred during a period from completion of a detected activity to elapse of a predetermined period of time, the detected activity as the activity with the likelihood of having been involved in the occurrence of the event.

5. The server apparatus of claim 1, wherein the one or more processors are further configured to derive, as the degree of involvement, a probability that the activity is being performed at the time at which the event has occurred.

6. The server apparatus of claim 1, wherein the one or more processors are further configured to provide, to an information processing apparatus of a user, information associated with the activity when the likelihood of having been involved in the occurrence of the event is above a threshold.

7. The server apparatus of claim 6, wherein the one or more processors are further configured to provide, to the information processing apparatus of the user, information associated with the activity with a high likelihood of being involved in earning a virtual award by the user above a threshold.

8. The server apparatus of claim 6, wherein the one or more processors are further configured to provide, to the information processing apparatus of the user, information associated with the activity with a high-likelihood of being involved in acquiring a game item by the user above a threshold.

9. An information processing apparatus that is operated by a user, the information processing apparatus comprising:
one or more processors including hardware,
wherein the one or more processors are further configured to cause an activity with a relatively high likelihood of being involved in earning a virtual award to be displayed.

10. The information processing apparatus of claim 9, wherein the one or more processors are further configured to cause information associated with a second virtual award that the user has not earned to be displayed.

11. A method comprising:
recording play data including identification information regarding an occurrence of an event during gameplay by a plurality of players and time information indicating a time at which the event has occurred;
specifying, from play data related to an activity having a completion condition, a period during which the activity has been performed;
specifying the activity with a likelihood of having been involved in the occurrence of the event, based at least in part on a relation between the period during which the activity has been performed and the time information included in the play data, and
deriving a degree of involvement indicating an extent of likelihood that the activity specified is involved in the occurrence of the event.

12. The method of claim 11, further comprising:
specifying a plurality of activities with a likelihood of having been involved in occurrence of a same event during the gameplay by the plurality of players, and
deriving a respective degree of involvement of each of the plurality of activities.

13. The method of claim 11, further comprising specifying the activity performed at the time at which the event has occurred.

14. The method of claim 11, further comprising specifying, in a case where the event has occurred during a period from completion of a detected activity to elapse of a predetermined period of time, the detected activity as the activity with the likelihood of having been involved in the occurrence of the event.

15. The method of claim 11, further comprising deriving, as the degree of involvement, a probability that the activity is being performed at the time at which the event has occurred.

16. The method of claim 11, further comprising providing, to an information processing apparatus of a user, information associated with the activity when the likelihood of having been involved in the occurrence of the event is above a threshold.

17. The method of claim 16, further comprising providing, to the information processing apparatus of the user, information associated with the activity with a likelihood of being involved in earning a virtual award by the user above a threshold.

18. The method of claim 16, further comprising providing, to the information processing apparatus of the user, information associated with the activity with a likelihood of being involved in acquiring a game item by the user above a threshold.
